(19) United States
(12) Patent Application Publication
(10) Pub. No.: US 2009/0124273 A1
(43) Pub. Date: May 14, 2009

(54) Method and Arrangement for Providing at Least One Piece of Information to a User Mobile Communication Device

(76) Inventor: Eberhard Back, Faehnrichstrasse (DE)

Correspondence Address: OLIFF & BERRIDGE, PLC, P.O. BOX 320850, ALEXANDRIA, VA, 22320-4850, US

(21) Appl. No.: 12/226,686

(22) PCT Filed: Apr. 25, 2007
(86) PCT No.: PCT/DE2007/000736

§ 371 Date: Dec. 12, 2008

(30) Foreign Application Priority Data
Apr. 25, 2006 (DE) 10 2006 019 628.7

(51) Int. Cl. H04W 4/14

(52) U.S. Cl. 455/466

(57) ABSTRACT

There is disclosed a process for providing at least one information message to a mobile communication device, especially a cellular phone of a user, wherein at least one NFC information message is requested by the user from a server, is processed by the server and the requested NFC information is sent via a mobile radio network to the mobile communication device, especially a cellular phone, PDA or the like of the user and wherein the received NFC information message is processed by at least one application program in the mobile communication device and is stored in at least one NFC memory such that a NFC receiver is capable of contact-less recalling the NFC information message. Moreover, a means for implementing such process is disclosed.

The invention relates to a process for providing at least one information message to a mobile communication device, especially to a cellular phone of a user in accordance with the preamble of claim 1 and a means for implementing said process according to claim 15.

From EP 1 630 712 A1, for instance, a near field communication system is known in which information is transmitted via NFC technology (NFC: near field communication) from a first mobile communication device, for example a cellular phone, to a second mobile communication device. The drawback of such communication systems is that the communication device for transmitting the NFC information message has to be taken by the user into the near field of the second NFC communication device, for example a NFC terminal so that the receiving area of the desired NFC information is locally restricted.

In contrast to that, the object underlying the invention is to provide a process and a device which permit providing an NFC information message to a mobile communication device independently of the position.

This object is achieved by a process for providing at least one information message to a mobile communication device of a user comprising the features of claim 1 and a means comprising the features of claim 15.

According to the invention, a user requests at least one NFC information message from a server, the user request is processed by the server and the requested NFC information message is transmitted via a mobile network to the mobile communication device, especially a cellular phone, PDA or the like of the user, wherein the received NFC information message is processed by at least one application program in the mobile communication device and is stored in at least one NFC memory so that a NFC receiver is capable of contact-less recalling the NFC information message. This solution has the advantage over the prior art according to EP 1 630 712 A1 that the user can request and receive NFC information independently of the position, because the NRC information message is provided to the communication device via the mobile network independently of the position. Thus a high user friendliness of the process according to the invention is achieved. NFC information includes, for instance, electronic tickets, financial data, biometric data or the like. An electronic ticket may be, for example, an admission ticket, a ticket or a data set which entitles the user to claim a service. Moreover, the NFC information may represent a physical access authorization for the user, especially in accordance with a company identity card or the like.

In a preferred variant the user request of the NFC information message is performed via a mobile communication device, for instance a cellular phone or a personal digital assistant (PDA), a computer system or a landline telephone.

In accordance with an especially preferred embodiment of the invention, the NFC information message is transmitted from the server to the mobile communication device by means of a radio message, especially SMS, Push SMS, MMS, EMS or a data transmission process, especially WAP Push, WAP, http, I-mode, GPRS, UMTS, CDMA or the like. The data transmission can be comprehensively secured by safety technologies already existing in the mobile radio system so that high data safety is ensured for the user. For instance, the NFC information message can be transmitted at least partly encrypted or signed. Furthermore, the mobile communication device of the user can be provided with a finger print sensor or the like to verify the user.

The application program is preferably embedded in the firmware of the mobile communication device or is applied to the same prior to delivery of the communication device or after delivery of the communication device to the user. The application program can be installed, for instance, in the mobile communication device employing either of the afore-mentioned data transmission processes. The application program can be made available to the user in this case by the server or any other source. The application program can be programmed for example in J2ME (Java 2 Micro Edition).

It has turned out to be especially advantageous when the mobile communication device includes a telephone member having a memory portion for radio messages, especially SMS, MMS, EMS etc. and a NFC member including a NFC memory for NFC information.

The NFC information message is identified especially by the application program, is extracted from the radio message and stored in the NFC memory ordered to be readable for the user and to be recallable by an NFC chip. It is of advantage in this context that a NFC information message is signaled to the user after its receipt acoustically via a loudspeaker or optically on an indicator means, for instance a display. Thus the user can immediately check the NFC information message. The mobile communication device is preferably provided with a menu control permitting a user-friendly administration and use of the NFC information. The NFC information can be sorted by the user, for instance, or blocked or released for recall by the NFC receiver.

The NFC information message is preferably recalled in the near field of the NFC receiver and permits taking an action. In the case of an advantageous further development of the process the NFC receiver transmits, upon receipt of the NFC information, an NFC message, especially status information, to the mobile communication device. In this way it can be signaled to the user, for instance, that his electronic ticket was accepted and validated by the NFC receiver.

In accordance with a first embodiment of the invention comprising an automatically controlled sequence, the NFC information message is provided with an NFC trigger code or an address component (port information) activating the application program in the mobile communication device. It is advantageous in this variant when the application program reads out the incoming mobile messages at defined time intervals and identifies and processes mobile messages containing an NFC trigger code or an address component.

In a preferred variant of the invention having a manually controlled sequence the user reads the radio message including the relevant NFC information and starts the application program that reads out the incoming radio messages and identifies and processes radio messages containing an NFC information message.

On principle, it is advantageous with the two variants, namely the automatically and the manually controlled sequence, when the application program employs a programming interface, for instance a Java programming interface according to the JSR 120 API Protocol, for processing the NFC information message between the memory portion for radio messages and the NFC portion including NFC memory for NFC information.

The application program stores the NFC information preferably in a MiFare®-1K-Emulator taking the international standard protocols provided for this purpose into account and in the MiFare®-Class-Libraries so that the NFC information message is made available ready for recall to the NFC receiver in the near field.

According to a preferred embodiment of the process, the application program indicates to the user that the operation is successfully completed and that the NFC information message is made available to the NFC receiver. Via the display of the mobile communication device a communication channel to the user can be opened in which the individual interactions are visible and thus reproducible.

In accordance with the invention, the means for implementing the process includes at least one server for processing a user request and for sending a NFC information message via a mobile network and an application program in the mobile communication device for processing the received NFC information and for storing it in at least one NFC memory so that a NFC receiver is capable of recalling the NFC information.

Other advantageous further developments of the invention form the subject matter of further subclaims.

Hereinafter a preferred embodiment of the invention shall be illustrated in detail by way of schematic drawings, in which

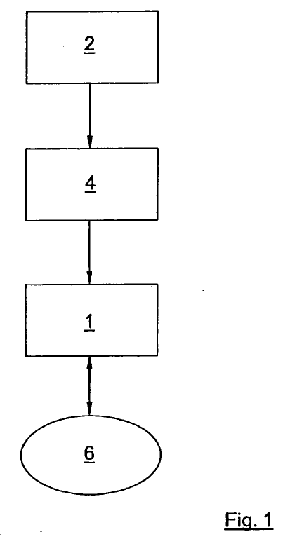

FIG. 1 shows a flow chart of a process according to the invention for providing a NFC information message to a mobile communication device of a user and

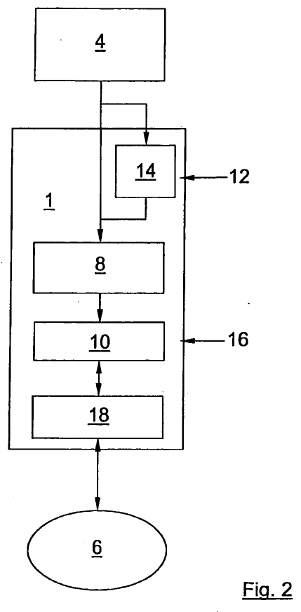

FIG. 2 shows a further flow chart of the process according to the invention.

FIG. 1 shows a flow chart of a process according to the invention for providing a NFC information message to a mobile communication device 1, for instance to a mobile cellular phone of a user. As a rule, the provision starts with the fact that the user requests at least one NFC information message from a server 4 for instance via a computer system 2. In a not represented embodiment the user request of NFC information is performed via a mobile communication device, especially a cellular phone, via a Personal Digital Assistant or a landline telephone. After that, the user request is processed by the server 4 and the requested NFC information message is transmitted via a mobile radio network to the cellular phone 1 of the user. NFC information includes, for instance, electronic tickets, financial data, biometric data or the like. The electronic ticket may be, for example, an admission ticket, a ticket or any other data set which entitles the user to claim a service. Furthermore, the NFC information may constitute a physical access authorization for the user, especially in accordance with a company identity card or the like. In the shown embodiment, the NFC information message is sent from the server 4 to the cellular phone 1 by means of a radio message, especially SMS, Push SMS, MMS or EMS. In a not shown process the NFC information message is transmitted by means of a data transmission process, for instance WAP Push, WAP, http, I-mode, GPRS, UMTS, CDMA or the like. The data transmission can be comprehensively secured by safety technologies already existing in the mobile radio system so that a high data safety is ensured for the user. For instance, the NFC information message can be transmitted at least partly encrypted. Moreover, the cellular phone 1 of the user may be provided with a finger print sensor to verify the user. The received NFC information is processed in the cellular phone 1 such that a NFC receiver 6 is capable of contact-less recalling the NFC information message. This shall be illustrated in detail hereinafter by way of FIG. 2 showing another flow chart of the process according to the invention.

In accordance with FIG. 2, the NFC information message sent from the server 4 to the cellular phone 1 via the mobile radio network is processed by an application program 8 (software application) in the cellular phone 1 and is stored in a NFC memory 10 such that the NFC receiver 6 is capable of contact-less recalling the NFC information message. This solution has the advantage that the user can request and receive NFC information independently of the position and high user friendliness is achieved. The cellular phone 1 comprises a telephone member 12 including a memory 14 for radio messages, especially SMS, MMS, EMS or the like and a NFC member 16 including the NFC memory 10 for NFC information. The NFC information incoming from the server 4 is identified by means of the application program 8, is extracted from the radio message and stored in the NFC memory 10 ordered to be readable for the user and recallable by a NFC chip 18. The NFC information message is signaled to the user upon receipt acoustically via a loudspeaker and optically on an indicator means, for instance a display, of the cellular phone (not shown). According to the represented process, the NFC information message is provided with a NFC trigger code or an address component activating the application program 8 in the cellular phone 1 so that the NFC information message is processed and provided automatically. In this variant it is advantageous when the application program 8 reads out the radio message memory 14 at defined time intervals and identifies and processes radio messages containing an NFC trigger code or an address component.

In a variant of the invention which is not represented the user reads the radio message including the relevant NFC information and manually starts the application program 8. The latter scans the radio message memory 14 and identifies and processes radio messages including an NFC information message. After that, the application is quit by the user.

Basically in both variants, namely the automatically and the manually controlled sequence, it is of advantage when the application program 8 employs a programming interface, e.g. a Java programming interface according to JSR 120 API Protocol for processing NFC information between the memory portion 14 for radio messages and the NFC member 16 including NFC memory 10 for NFC information. The application program is embedded in the firmware of the cellular phone 1 or is applied to the same prior to or after delivery of the cellular phone 1 to the user. For instance, the application program 8 can be installed in the cellular phone 1 making use of either of the afore-mentioned data transmission processes, wherein the application program 8 is made available in this case by the server 4 or any other source. The application program 8 preferably stores the NFC information in a MiFare®-1K-Emulator taking the international standard protocols provided for this purpose into account and in the MiFare®-Class-Libraries so that the NFC information message is made available to the NFC receiver 6 ready for recall in the near field. Finally the application program 8 indicates to the user via a display (not shown) of the cellular phone 1, for instance, that the operation has been successfully completed and that the NFC information is made available to the NFC receiver 6 ready for recall. Upon receipt of the NFC information the NFC receiver 6 transmits status information to the cellular phone 1 in order to signal to the user, for example, that his electronic ticket was accepted and validated by the NFC receiver 6.

The process according to the invention is not restricted to the NFC information described, rather any information known from the state of the art required for a contact-less application, e.g. for payment transactions, can be transmitted by the process according to the invention.

There is disclosed a process for providing at least one information message to a mobile communication device 1, especially a cellular phone of a user, wherein at least one NFC information message is requested by the user from a server 4, is processed by the server 4 and the requested NFC information message is sent via a mobile radio network to the mobile communication device 1, especially a cellular phone, PDA or the like of the user, and wherein the received NFC information message is processed by at least one application program 8 in the mobile communication device 1 and is stored in at least one NFC memory 10 such that a NFC receiver 6 is capable of contact-less recalling the NFC information. Moreover, a means for implementing such process is disclosed.

### LIST OF REFERENCE NUMBERS

1 mobile communication device
2 computer system
4 server
6 NFC receiver
8 application program
10 NFC memory
12 telephone member
14 radio message memory
16 NFC member
18 NFC chip

1-15. (canceled)

16. A process for providing at least one information message to a mobile communication device (1) of a user, especially to a cellular phone, comprising the steps of:
a) requesting a NFC information message, especially an electronic ticket, financial data, biometric data or the like, from a server (4) by the user;
b) processing the user request by the server (4) and sending the NFC information message via a mobile radio network to the mobile communication device (1) of the user;
c) processing the received NFC information message by at least one application program (8) in the mobile communication device (1) and storing the NFC information message in at least one NFC memory (10) so that an NFC receiver (6) is capable of recalling the NFC information message, wherein the mobile communication device (1) includes a telephone member (12) having a memory portion (14) for radio messages, especially SMS, MMS, EMS or the like, and a NFC member (16) having a NFC memory (10) for NFC information messages, and wherein the NFC information message is identified by means of the application program (8), is extracted from the radio message and stored in the NFC memory (10) ordered to be readable for the user and recallable by a NFC chip (18).

17. A process according to claim 16, wherein the user request of NFC information is made via the mobile communication device (1), a PC or a landline telephone.

18. A process according to claim 16, wherein the NFC information message is sent to the mobile communication device (1) by a radio message, especially SMS, Push SMS, MMS, EMS and/or a data transmission process, especially WAP Push, WAP, http, I-mode, GPRS, UMTS, CDMA or the like.

19. A process according to claim 16, wherein the application program (8) is embedded in the firmware of the mobile communication device (1), is applied to the same prior to delivery of the mobile communication device (1) to the user or after delivery of the mobile communication device (1).

20. A process according to claim 16, wherein the NFC information message is recalled in the near field of the NFC receiver (6) and permits taking an action.

21. A process according to claim 16, wherein the NFC receiver (6) transmits a NFC message, especially status information, to the mobile communication device (1) upon receipt of the NFC information message.

22. A process according to claim 16, wherein the NFC information message includes at least one NFC trigger code and/or one address component that activates the application program (8) in the mobile communication device (1).

23. A process according to claim 22, wherein the application program (8) reads out the incoming radio messages (14) at defined time intervals and identifies and processes radio messages including a NFC trigger code and/or an address component.

24. A process according to claim 16, wherein the user starts the application program which reads out the incoming radio messages (14) and identifies and processes radio messages that include a NFC information message.

25. A process according to claim 16, wherein the application program (8) employs a programming interface, especially according to the JSR 120 API Protocol, for processing the NFC information message.

26. A process according to claim 16, wherein the application program (8) stores the NFC information in a MiFare®-1K-Emulator.

27. A process according to claim 16, wherein the application program (8) indicates to the user that the operation has been successfully completed and that the NFC information is made available to the NFC receiver (6).

28. A means for implementing a process for providing at least one information message to a mobile communication device (1) of a user, comprising at least one server (4) for processing a user request and for sending a NFC information message via a mobile radio network, and comprising an application program (8) in the mobile communication device (1) for processing the received NFC information message and for storing in at least one NFC memory (10) of a NFC member (16) so that a NFC receiver (6) is capable of recalling the NFC information message.
